(19) United States
(12) Patent Application Publication
(10) Pub. No.: US 2013/0021166 A1
(43) Pub. Date: Jan. 24, 2013

(54) SYSTEM AND METHOD FOR BOREHOLE COMMUNICATION

(71) Applicants: Jagdish Shah, Cheshire, CT (US); Julius Kusuma, Somerville, MA (US)

(72) Inventors: Jagdish Shah, Cheshire, CT (US); Julius Kusuma, Somerville, MA (US)

(73) Assignee: Schlumberger Technology Corporation, Cambridge, MA (US)

(21) Appl. No.: 13/186,886

(22) Filed: Jul. 20, 2011

(51) Int. Cl. G01V 3/00

(52) U.S. Cl. 340/853.1

(57) ABSTRACT

To produce a desired telemetry signal, the desired telemetry signal is first determined and then decomposed into two or more component signals. For each component signal, commands are sent to an individual modulator. The individual modulators each produce individual signals according to their received commands. The individual signals from each individual modulator are combined to produce the desired telemetry signal, or the individual signals from each individual modulator are allowed to combine to produce the desired telemetry signal. A telemetry system that produces such desired telemetry signals includes an uplink transmitter/receiver pair, a downlink transmitter/receiver pair, or both pairs, wherein each uplink transmitter and each downlink receiver is disposed in a wellbore. Two or more modulators are provided, as is a telemetry signal generator having a processor capable of decomposing a desired telemetry signal into two or more component signals and issuing commands to control the two or more modulators.

### CROSS-REFERENCE TO OTHER APPLICATIONS

N/A

### BACKGROUND

1. Technical Field

This invention relates to wellbore communication systems and particularly to systems and methods for generating and transmitting data signals between the surface of the earth and the bottom hole assembly while drilling a borehole.

2. Related Art

Wells are generally drilled into the ground to recover natural deposits of hydrocarbons and other desirable materials trapped in geological formations in the Earth's crust. A well is typically drilled using a drill bit attached to the lower end of a drill string. The well is drilled so that it penetrates the subsurface formations containing the trapped materials and the materials can be recovered.

At the bottom end of the drill string is a “bottom hole assembly” (“BHA”). The BHA includes the drill bit along with sensors, control mechanisms, and the required circuitry. A typical BHA includes sensors that measure various properties of the formation and of the fluid that is contained in the formation. A BHA may also include sensors that measure the BHA's orientation and position.

The drilling operations may be controlled by an operator at the surface or operators at a remote operations support center. The drill string is rotated at a desired rate by a rotary table, or top drive, at the surface, and the operator controls the weight-on-bit and other operating parameters of the drilling process.

Another aspect of drilling and well control relates to the drilling fluid, called “mud”. The mud is a fluid that is pumped from the surface to the drill bit by way of the drill string. The mud serves to cool and lubricate the drill bit, and it carries the drill cuttings back to the surface. The density of the mud is carefully controlled to maintain the hydrostatic pressure in the borehole at desired levels.

In order for the operator to be aware of the measurements made by the sensors in the BHA, and for the operator to be able to control the direction of the drill bit, communication between the operator at the surface and the BHA are necessary. A “downlink” is a communication from the surface to the BHA. Based on the data collected by the sensors in the BHA, an operator may desire to send a command to the BHA. A common command is an instruction for the BHA to change the direction of drilling.

Likewise, an “uplink” is a communication from the BHA to the surface. An uplink is typically a transmission of the data collected by the sensors in the BHA. For example, it is often important for an operator to know the BHA orientation. Thus, the orientation data collected by sensors in the BHA is often transmitted to the surface. Uplink communications are also used to confirm that a downlink command was correctly understood.

One common method of communication is called “mud pulse telemetry.” Mud pulse telemetry is a method of sending signals, either downlinks or uplinks, by creating pressure and/or flow rate pulses in the mud. These pulses may be detected by sensors at the receiving location. For example, in a downlink operation, a change in the pressure or the flow rate of the mud being pumped down the drill string may be detected by a sensor in the BHA. The pattern of the pulses, such as the frequency, the phase, and the amplitude, may be detected by the sensors and interpreted so that the command may be understood by the BHA.

Mud pulse telemetry systems are typically classified as one of two species depending upon the type of pressure pulse generator used, although “hybrid” systems have been disclosed. The first species uses a valving “poppet” system to generate a series of either positive or negative, and essentially discrete, pressure pulses which are digital representations of transmitted data. The second species, an example of which is disclosed in U.S. Pat. No. 3,309,656, comprises a rotary valve or “mud siren” pressure pulse generator which repeatedly interrupts the flow of the drilling fluid, and thus causes varying pressure waves to be generated in the drilling fluid at a carrier frequency that is proportional to the rate of interruption. Downhole sensor response data is transmitted to the surface of the earth by modulating the acoustic carrier frequency. A related design is that of the oscillating valve, as disclosed in U.S. Pat. No. 6,626,253, wherein the rotor oscillates relative to the stator, changing directions every 180 degrees, repeatedly interrupting the flow of the drilling fluid and causing varying pressure waves to be generated.

With reference to FIG. 1, a drilling rig 10 includes a drive mechanism 12 to provide a driving torque to a drill string 14. The lower end of the drill string 14 extends into a wellbore 30 and carries a drill bit 16 to drill an underground formation 18. During drilling operations, drilling mud 20 is drawn from a mud pit 22 on a surface 29 via one or more pumps 24 (e.g., reciprocating pumps). The drilling mud 20 is circulated through a mud line 26 down through the drill string 14, through the drill bit 16, and back to the surface 29 via an annulus 28 between the drill string 14 and the wall of the wellbore 30. Upon reaching the surface 29, the drilling mud 20 is discharged through a line 32 into the mud pit 22 so that rock and/or other well debris carried in the mud can settle to the bottom of the mud pit 22 before the drilling mud 20 is recirculated.

Referring now to FIG. 1, one known wellbore telemetry system 100 is depicted including a downhole measurement while drilling (MWD) tool 34 is incorporated in the drill string 14 near the drill bit 16 for the acquisition and transmission of downhole data or information. The MWD tool 34 includes an electronic sensor package 36 and a mudflow wellbore telemetry device 38. The mudflow telemetry device 38 can selectively block the passage of the mud 20 through the drill string 14 to cause pressure changes in the mud line 26. In other words, the wellbore telemetry device 38 can be used to modulate the pressure in the mud 20 to transmit data from the sensor package 36 to the surface 29. Modulated changes in pressure are detected by a pressure transducer 40 and a pump piston sensor 42, both of which are coupled to a surface system processor (not shown). The surface system processor interprets the modulated changes in pressure to reconstruct the data collected and sent by the sensor package 36. The modulation and demodulation of a pressure wave are described in detail in commonly assigned U.S. Pat. No. 5,375,098, which is incorporated by reference herein in its entirety.

The surface system processor may be implemented using any desired combination of hardware and/or software. For example, a personal computer platform, workstation platform, etc. may store on a computer readable medium (e.g., a magnetic or optical hard disk, random access memory, etc.) and execute one or more software routines, programs, machine readable code or instructions, etc. to perform the operations described herein. Additionally or alternatively, the surface system processor may use dedicated hardware or logic such as, for example, application specific integrated circuits, configured programmable logic controllers, discrete logic, analog circuitry, passive electrical components, etc. to perform the functions or operations described herein.

Still further, while the surface system processor can be positioned relatively proximate to the drilling rig (i.e., substantially co-located with the drilling rig), some part of or the entire surface system processor may alternatively be located relatively remotely from the rig. For example, the surface system processor may be operationally and/or communicatively coupled to the wellbore telemetry component 18 via any combination of one or more wireless or hardwired communication links (not shown). Such communication links may include communications via a packet switched network (e.g., the Internet), hardwired telephone lines, cellular communication links and/or other radio frequency based communication links, etc. using any desired communication protocol.

Additionally one or more of the components of the BHA may include one or more processors or processing units (e.g., a microprocessor, an application specific integrated circuit, etc.) to manipulate and/or analyze data collected by the components at a downhole location rather than at the surface.

The highest-performing mud pulse systems today use a single modulator, typically consisting of a stator and a rotor. The relative position between the stator and rotor, together with the drilling mud/fluid conditions, determine the amplitude of the telemetry signal generated. In addition, for a single modulator, the amplitude of the differential pressure signal generated is proportional to the square of the inverse of the flow area. The speed at which the rotor can be moved relative to the stator limits the bandwidth of the signal generated.

### SUMMARY

To produce a desired telemetry signal, the desired telemetry signal is first determined and then decomposed into two or more component signals. For each component signal, commands are sent to an individual modulator. The individual modulators each produce individual signals according to their received commands. The individual signals from each individual modulator are combined to produce the desired telemetry signal, or the individual signals from each individual modulator are allowed to combine to produce the desired telemetry signal. A telemetry system that produces such desired telemetry signals includes an uplink transmitter/receiver pair, a downlink transmitter/receiver pair, or both pairs, wherein each uplink transmitter and each downlink receiver is disposed in a wellbore. Two or more modulators are provided, as is a telemetry signal generator having a processor capable of decomposing a desired telemetry signal into two or more component signals and issuing commands to control the two or more modulators based on the two or more component signals.

Other aspects and advantages will become apparent from the following description and the attached claims.

### BRIEF DESCRIPTION OF THE FIGURES

So that the above recited features and advantages of the present invention can be understood in detail, a more particular description of the invention, briefly summarized above, may be had by reference to the embodiments thereof that are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic view, partially in cross-section, of prior art showing a known measurement while drilling tool and wellbore telemetry device connected to a drill string and deployed from a rig into a wellbore.

FIG. 2 is a schematic drawing of an embodiment of a multi-component telemetry system, constructed in accordance with the present disclosure.

FIG. 3 is a block diagram showing certain components of an embodiment of the multi-component telemetry system of FIG. 2, in accordance with the present disclosure.

FIG. 4 is a plot showing a polyphase decomposition that can be used in a multi-component telemetry system, in accordance with the present disclosure.

FIG. 5 is a plot showing a wavelet/multiscale decomposition that can be used in a multi-component telemetry system, in accordance with the present disclosure.

FIG. 6 is a plot showing a Fourier decomposition that can be used in a multi-component telemetry system, in accordance with the present disclosure.

FIG. 7 is a plot showing two constituent waveforms and their sum, in accordance with the present disclosure.

FIG. 8 is a flowchart showing the steps of an exemplary embodiment of a multi-component telemetry system, in accordance with the present disclosure.

FIG. 9A is a schematic drawing of an embodiment of a carrier signal modulator in a multi-component telemetry system, in accordance with the present disclosure.

FIG. 9B is a schematic drawing of an embodiment of a first flow area control modulator in a multi-component telemetry system, in accordance with the present disclosure.

FIG. 9C is a schematic drawing of an embodiment of a second flow area control modulator in a multi-component telemetry system, in accordance with the present disclosure.

FIG. 10A is a schematic drawing of an embodiment of a multi-component telemetry system with synchronization, in accordance with the present disclosure.

FIG. 10B is a schematic drawing of an embodiment of a multi-component telemetry system with synchronization, in accordance with the present disclosure.

FIG. 10C is a schematic drawing of an embodiment of a multi-component telemetry system with synchronization, in accordance with the present disclosure.

FIG. 10D is a schematic drawing of an embodiment of a multi-component telemetry system without synchronization, in accordance with the present disclosure.

### DETAILED DESCRIPTION

Some embodiments will now be described with reference to the figures. Like elements in the various figures will be referenced with like numbers for consistency. In the following description, numerous details are set forth to provide an understanding of various embodiments and/or features. However, it will be understood by those skilled in the art that some embodiments may be practiced without many of these details and that numerous variations or modifications from the described embodiments are possible. As used here, the terms “above” and “below”, “up” and “down”, “upper” and “lower”, “upwardly” and “downwardly”, and other like terms indicating relative positions above or below a given point or element are used in this description to more clearly describe certain embodiments. However, when applied to equipment and methods for use in wells that are deviated or horizontal, such terms may refer to a left to right, right to left, or diagonal relationship as appropriate.

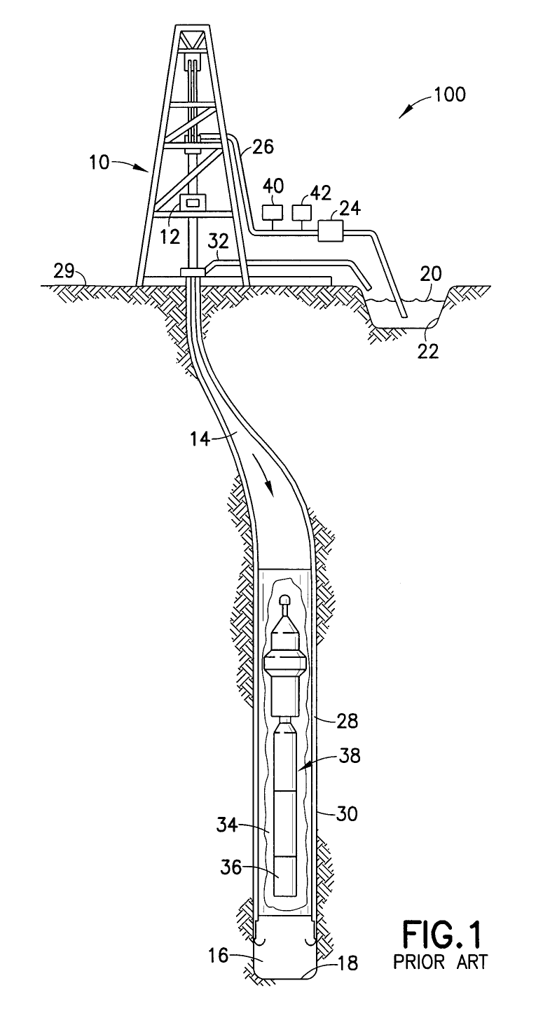

FIG. 1 illustrates a well site in which various embodiments of a telemetry system having a wider bandwidth than prior art systems can be employed. The well site can be onshore or offshore. In this exemplary system, borehole 30 is formed in subsurface formations by rotary drilling in a manner that is well known. Some embodiments can also use directional drilling.

Current mud pulse mechanical modulators are limited in their (rotational) motion velocities. As a result, the bandwidth of the telemetry signal generated is also limited. In many cases it is desirable to generate a wide bandwidth signal. However, it is believed that using a modulator at a higher rotational velocity will increase wear and reduce reliability.

Multiple modulators may be used wherein each modulator generates one signal component, such that the combined signal has higher bandwidth than each of the individual signal components. Each modulator operates at a lower angular velocity than would a single modulator capable of producing the bandwidth of the generated signal. Signals generated by multiple modulators are additive, so long as the modulators are spaced sufficiently far apart.

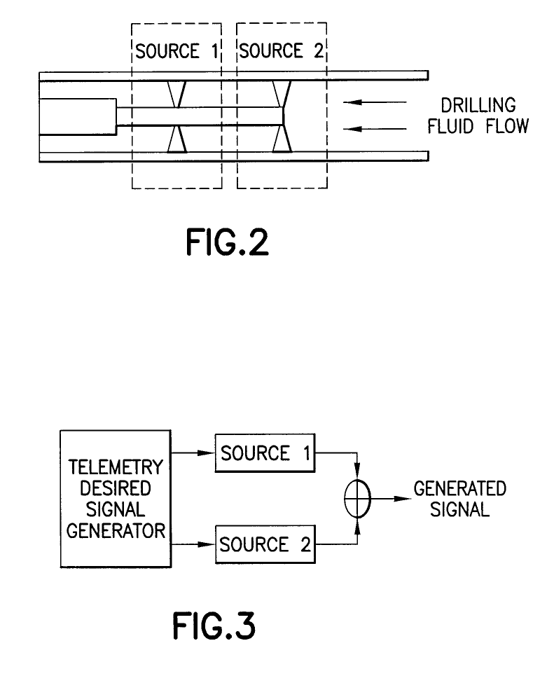

An example embodiment of a multiple modulator telemetry system 200 is shown in FIG. 2. FIG. 2 shows a drill string 202 through which drilling fluid flows, as indicated by the direction arrows in the interior of drill string 202. The drilling fluid passes through a source 204 and a source 206. Sources 204, 206 are preferably mud sirens or oscillatory valves. The action or rotational motion of sources 204, 206 are respectively controlled by a telemetry signal generator 208.

Functionally, the system operates according to the block diagram of FIG. 3. Telemetry signal generator 208 seeks to generate some desired signal and sends appropriate control signals to sources 204, 206, respectively (step 302). The signals produced from sources 204, 206 combine to produce the desired signal (step 304). While only two modulators or sources 204, 206 are shown in this exemplary embodiment, more sources could be used, if desired.

There are at least two ways to exploit multiple modulators. One way is for each modulator to generate a signal such that the overall signal is a linear combination of those signals, as described briefly above. Another way is to control the effective overall flow area. This can be done, for example, by placing the modulators in sufficiently close proximity to each other.

Regarding the linear decomposition, there are several ways to decompose one signal into two or more components. Examples include, but are not limited to, Fourier decomposition, wavelet or multiscale decomposition, and polyphase decomposition. To illustrate using polyphase decomposition, let the desired signal be x(t), and consider a decomposition of a signal into M components. Index m denotes the signals to be generated by the m-th modulator. We represent these modulation signals in (complex) baseband, thus a carrier term can be added:

$$x ( t ) = {\sum }_{m = 0}^{M - 1} {x}_{m} ( t - m \cdot {T}_{m} ) .$$

Each xₘ(t) is a polyphase component. The time delay between the polyphase components is determined by Tₘ, which traditionally is fixed for all m.

The polyphase components can come, for example, from a linear modulation such as:

$${x}_{m} ( t ) = {\sum }_{n = 0}^{N - 1} {c}_{n}^{( m )} \cdot {g}^{( m )} ( t - {nT}_{s}^{( m )} ) .$$

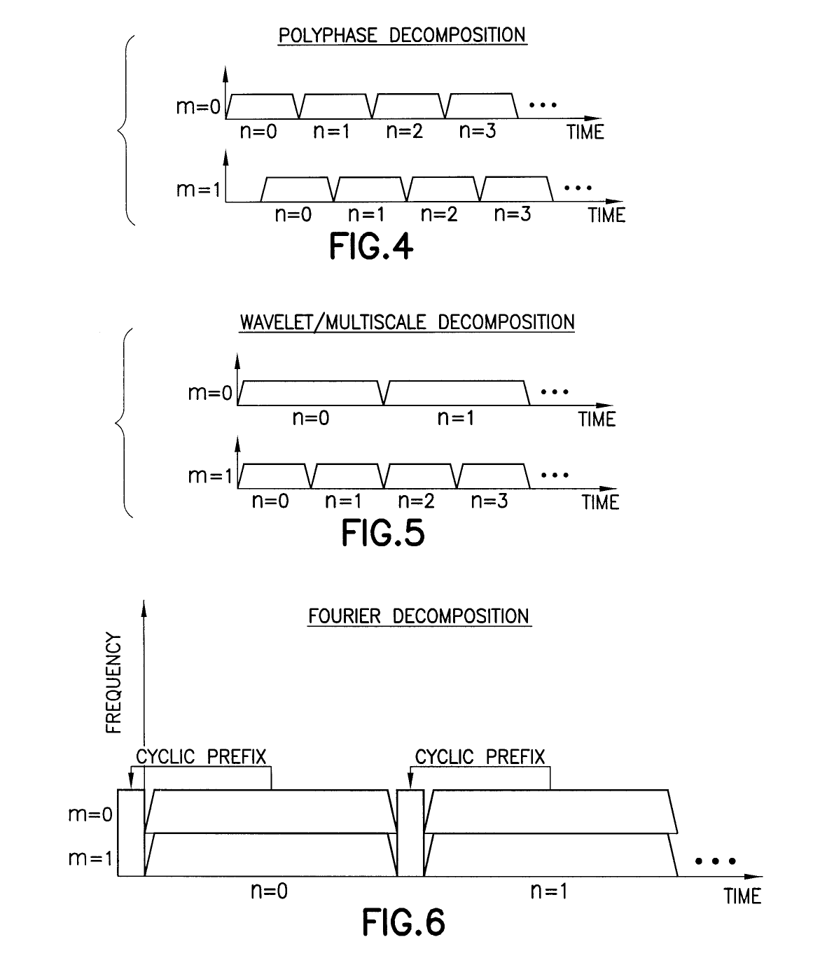

The coefficients cₙ^{(m)} are information-bearing symbols. Alternatively, each xₘ(t) can come from other modulations such as Minimum-Shift Keying, Continuous-Phase Modulation, Phase-Shift Keying, Quadrature Amplitude Modulation, Multi-tone Modulation, etc. In some cases, it may be that each polyphase component itself cannot be decoded individually. FIG. 4 shows two graphs of exemplary polyphase decomposition components as a function of time in which the index m equals zero and the index n ranges from zero to three, and m equals one and n again ranges from zero to three.

Another possible decomposition is the wavelet or multiscale decomposition Again, let index m denote the signals to be generated by the m-th modulator. We represent these modulation signals in (complex) baseband, thus the following carrier term can be added:

$$x ( t ) = {\sum }_{m = 0}^{M - 1} {\sum }_{n = 0}^{N - 1} {c}_{n}^{( m )} {g}_{m} ( t - {sT}_{m} ) .$$

The coefficients cₙ^{(m)} again are information-bearing symbols. FIG. 5 shows two graphs of exemplary wavelet decomposition components as a function of time in which the index m equals zero and the index n ranges from zero to one, and m equals one and n ranges from zero to three.

Another possible decomposition is the Fourier decomposition. Again, index m denotes the signals to be generated by the m-th modulator and we represent these modulation signals in (complex) baseband. Thus, the following carrier term can be added:

$$x ( t ) = {\sum }_{m = 0}^{M - 1} {\sum }_{n = 0}^{N - 1} {c}_{n}^{( m )} exp ( i 2 π kt / T ) .$$

The coefficients cₙ^{(m)} are again information-bearing symbols. For generality, we may write the above as:

$$x ( t ) = {\sum }_{m = 0}^{M - 1} {\sum }_{n = 0}^{N - 1} {c}_{n}^{( m )} exp ( i 2 π t / T ( k ) ) .$$

In this way, the subcarriers used are not necessarily contiguous nor uniformly spaced. To improve demodulation, a cyclic prefix, or postfix, or guard interval, can be added. Then,

$$x ( t ) = {\sum }_{m = 0}^{M - 1} {\sum }_{n = 0}^{N - 1} {c}_{n}^{( m )} exp ( i 2 π kt / T ) , for t ∈ [ 0 , T ) ,$$

and the cyclic prefix is:

$$x ( t ) = {\sum }_{m = 0}^{M - 1} {\sum }_{n = 0}^{N - 1} {c}_{n}^{( m )} exp ( i 2 π kt / T ) , for t ∈ [ - {T}_{g} , 0 ) .$$

FIG. 6 shows a graph of Fourier decomposition components as a function of time in which the index m equals zero and the index n ranges from zero to one, and m equals one and n again ranges from zero to one. The graph also shows the cyclic prefix.

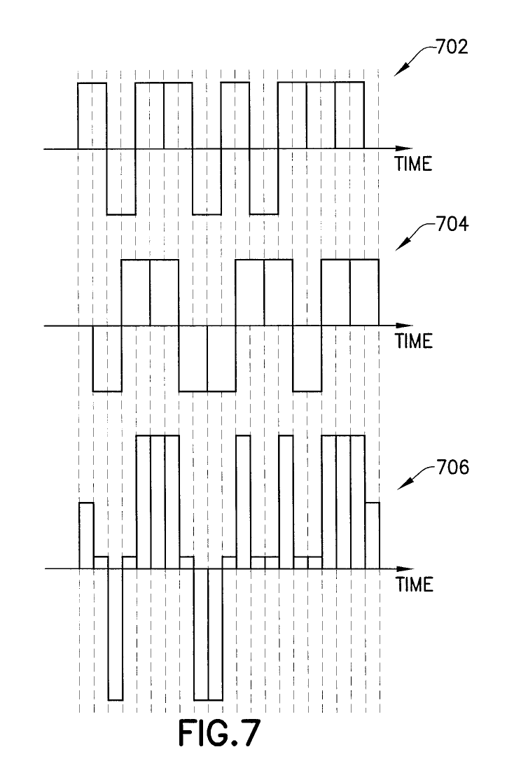

In FIG. 7, we have signals x₁(t) 702, x₂(t) 704, and their sum x(t) 706. The figure shows how the constituent amplitudes combine. The second constituent signal is seen to have slightly larger amplitude than the first since the out-of-phase signals do not sum to zero. The bandwidth of the resulting signal in this case is twice that of the component signals.

The signals from two or more modulators can be combined such that the overall performance of the telemetry system is increased in terms of data rate, robustness to noise, and robustness to propagation distortion. In addition, less power is required to create the final signal than would be required by a single modulator. Because power consumption goes up with frequency and bandwidth, and because downhole power is limited, the frequency and bandwidth of a signal from a single modulator is limited.

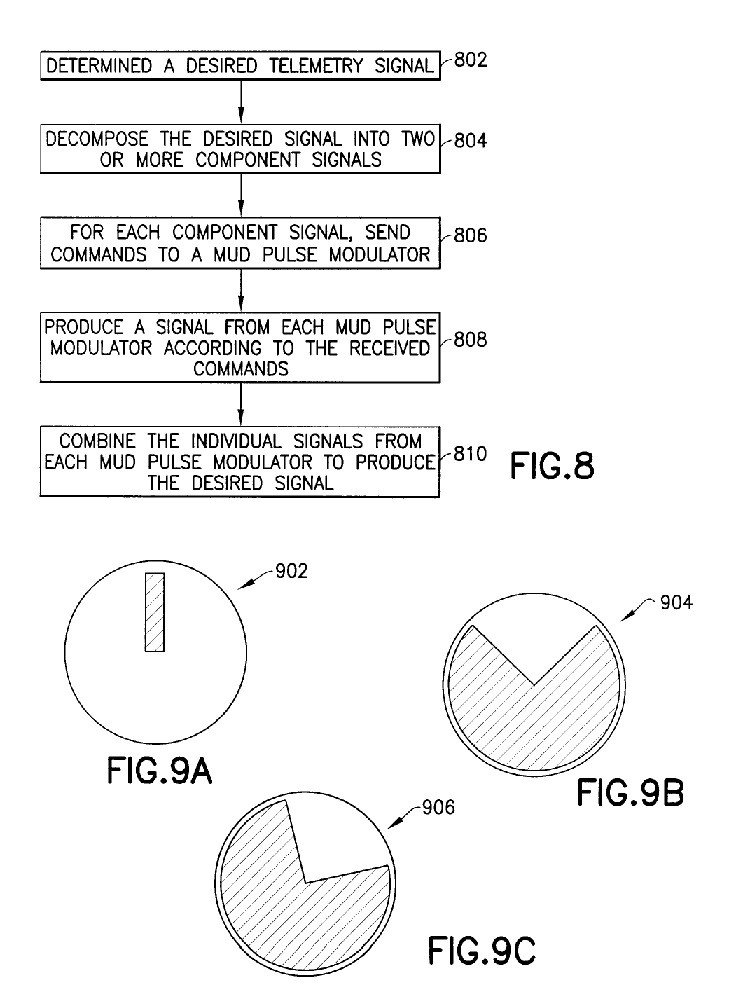

FIG. 8 shows exemplary steps of one embodiment of this disclosure. A desired telemetry signal is determined (step 802) and decomposed into two or more component signals (step 804). For each component signal, commands are sent to a mud pulse modulator (step 806). A separate mud pulse modulator is used for each component signal. Each mud pulse modulator produces a signal according to the received commands (step 808). The individual signals from each mud pulse modulator combine to produce the desired signal (step 810).

When the modulators are in close proximity with each other, the signals generated will interact in a nonlinear fashion. FIGS. 9A, 9B, and 9C show multiple modulator rotors used to control the effective flow area. FIG. 9A shows a modulator 902 that rotates to generate a carrier modulation, while FIGS. 9B and 9C show modulators 904, 906, respectively, that generate the envelope of the signal. Let A1(z,t) and A2(z,t) describe the flow areas of the two modulators 904, 906, z describing a coordinate system normal to the flow direction to represent the flow area, and t describing time. The resulting differential pressure signal will be proportional to:

x(t)∝1/A(t),

where A(t) is the effective flow area determined by the two modulators. As an approximation,

A(t)=∫ₓA₁(x,t)·A₂(x,t)dx.

Thus, by having several modulators with one or different shapes, we can generate a signal x(t) that depends on their motions. When a stator is present, or multiple modulators are present, then:

$$A ( t ) = {\int }_{z} {\prod }_{m = 0}^{M - 1} {A}_{m} ( z , t ) d z .$$

As an example, one modulator can control the effective flow area between itself and a rotor, and a second modulator can rotate and effectively generate carrier modulation.

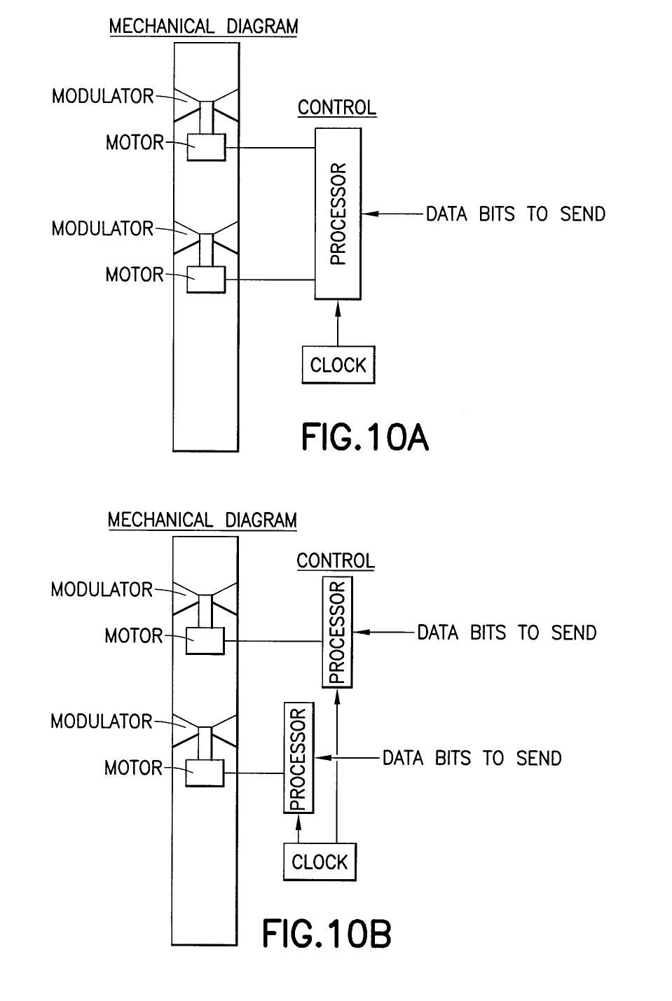

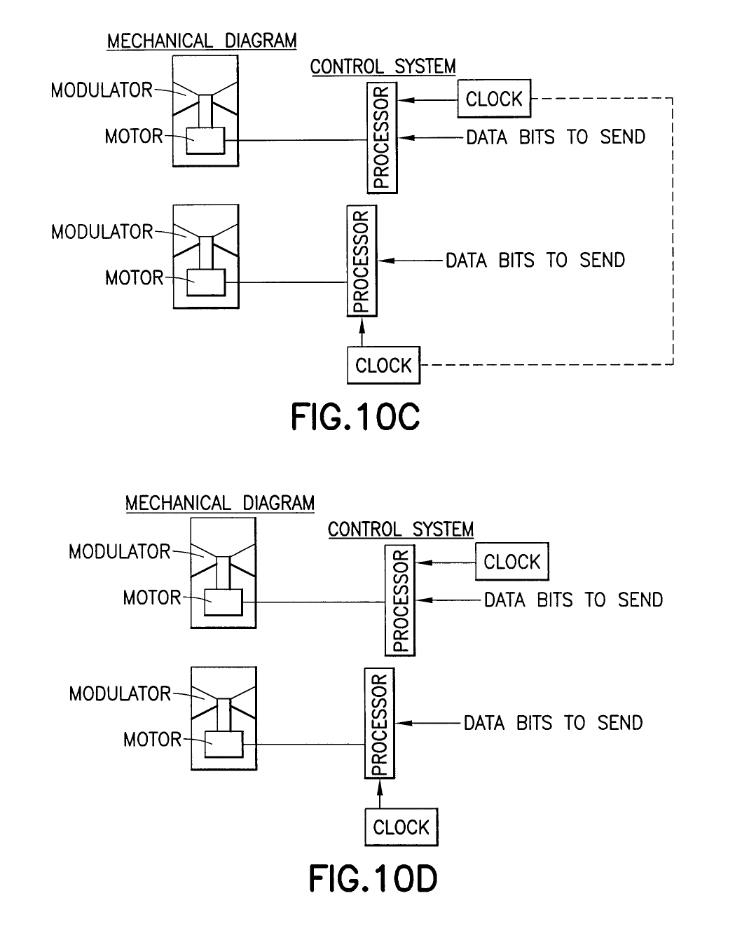

The multiple modulators may be controlled by one controller and thus be inherently synchronized (see FIG. 10A). Alternatively, the multiple modulators may each have their own controller, but share the same clock such that they are synchronized (see FIG. 10B). The multiple modulators may each have their own controller, each with its own clock. Those clocks may (see FIG. 10C) or may not (see FIG. 10D) be synchronized. For each case, each controller may encode some parts of the information bits if each decomposed component can be encoded and decoded separately, or the controller may encode all the information bits if the decomposed components do not individually convey integral pieces of information.

This description is intended for purposes of illustration only and should not be construed in a limiting sense. The scope of this invention should be determined only by the language of the claims that follow. The term “comprising” within the claims is intended to mean “including at least” such that the recited listing of elements in a claim are an open group. “A,” “an” and other singular terms are intended to include the plural forms thereof unless specifically excluded.

It should be appreciated that while the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method, comprising:
determining a desired telemetry signal;
decomposing the desired telemetry signal into two or more component signals;
sending, for each of the two or more component signals, commands to an individual modulator;
producing an individual signal from each individual modulator according to the received commands; and
combining the individual signals from each individual modulator to produce the desired telemetry signal or allowing the individual signals from each individual modulator to combine to produce the desired telemetry signal.

2. The method of claim 1, wherein an individual signal conveys integral information whereby the signal can be decoded individually.

3. The method of claim 1, further comprising decoding the desired telemetry signal.

4. The method of claim 1, wherein the desired telemetry signal is an uplink or a downlink.

5. The method of claim 1, wherein the decomposing is based on polyphase decomposition, wavelet decomposition, or Fourier decomposition.

6. The method of claim 1, wherein each modulator comprises a rotary valve, an oscillating valve, or a poppet valve.

7. The method of claim 1, wherein all modulators are within one tool and controlled by one controller.

8. The method of claim 1, wherein each modulator is controlled by an individual controller, and all controllers are driven by a single clock.

9. The method of claim 1, wherein each modulator is controlled by an individual controller, and each controller is driven by a separate clock.

10. The method of claim 9, wherein all clocks are synchronized.

11. The method of claim 1, wherein the desired telemetry signal has a wider bandwidth than any of the individual signals.

12. The method of claim 1, wherein the desired telemetry signal has less noise than a comparable signal produced by a single modulator.

13. The method of claim 1, wherein the desired telemetry signal has less propagation distortion than a comparable signal produced by a single modulator.

14. The method of claim 1, wherein the power to produce the desired telemetry signal is less than the power required to produce a comparable signal using a single modulator.

15. The method of claim 1, wherein the modulators use an effective flow area to produce the individual signals.

16. The method of claim 1, wherein a first individual modulator controls the effective flow area between itself and a rotor, and a second individual modulator generates a carrier modulation or a baseband modulation.

17. The method of claim 16, wherein the first modulator is an oscillating valve or a poppet valve, and the second modulator is a rotary valve.

18. A telemetry system, comprising:
an uplink transmitter/receiver pair, a downlink transmitter/receiver pair, or both pairs, wherein each uplink transmitter and each downlink receiver is disposed in a wellbore;
two or more modulators; and
a telemetry signal generator having a processor capable of:
decomposing a desired telemetry signal into two or more component signals; and
issuing commands to control the two or more modulators based on the two or more component signals.

19. The telemetry system of claim 18 wherein each uplink receiver and each downlink transmitter is located on or near the earth's surface.

20. The telemetry system of claim 18, wherein each modulator comprises a rotary valve, an oscillating valve, or a poppet valve.
